(19) United States
(12) Patent Application Publication
(10) Pub. No.: US 2013/0329004 A1
(43) Pub. Date: Dec. 12, 2013

(54) Method of and Apparatus for Image Enhancement

(71) Applicants: Farhan A. Baqai, Fremont (US); Vincent Y. Wong, Santa Clara, CA (US); Todd S. Sachs, Palo Alto, CA (US)

(72) Inventors: Farhan A. Baqai, Fremont (US); Vincent Y. Wong, Santa Clara, CA (US); Todd S. Sachs, Palo Alto, CA (US)

(73) Assignee: APPLE INC., Cupertino, CA (US)

(21) Appl. No.: 13/492,302

(22) Filed: Jun. 8, 2012

Related U.S. Application Data
(60) Provisional application No. 61/656,078, filed on Jun. 6, 2012.

(51) Int. Cl. H04N 5/217; H04N 7/00

(52) U.S. Cl. 348/36; 348/241; 348/E05.079; 348/E07.001

(57) ABSTRACT

Image enhancement by separating the image signals, either Y or RGB, into a series of bands and performing noise reduction on bands below a given frequency but not on bands above that frequency. The bands are summed to develop the image enhanced signals. This results in improved sharpness and masking of image processing pipeline artifacts. Chroma signals are not separated into bands but have noise reduction applied to the full bandwidth signals. The higher frequency band is attenuated or amplified based on light level. The noise reduction has thresholds based on measured parameters, such as signal frequency, gain and light level, provided in a lookup table. The window size used for the noise reduction varies with the light level as well, smaller windows sizes being used in bright light and increasing window sizes as light levels decrease. Panoramic images are handled in a similar fashion.

### CROSS REFERENCE TO RELATED APPLICATIONS

This application claims the benefit under 35 U.S.C. §119(e) of U.S. Provisional Patent Application Ser. No. 61/656,078 entitled “Method of and Apparatus for Image Enhancement,” filed Jun. 6, 2012, which is hereby incorporated by reference.

### BACKGROUND OF THE INVENTION

1. Field of the Invention

The invention is related to image processing of captured images

2. Description of the Related Art

At the image sensor, noise can be considered to be white (no frequency dependence) with a signal dependent variance due to shot noise. It is largely un-correlated between channels (R, G, B). At the end of the pipeline (after undergoing noise reduction, demosaicking, white balancing, filtering, color enhancement, and compression in the image signal processor), image noise is dependent on signal, frequency, illuminant, and light level, and is also correlated between channels as described in U.S. Pat. No. 8,108,211, hereby incorporated by reference. This problem is very significant in mobile phone or point-and-shoot camera where pixels are much smaller than DSLR sensors, hence they have lower electron well capacity, further deteriorating the signal to noise ratio, especially in low-light situations.

The noise reduction in a mobile phone camera pipeline is fairly basic. It is constrained by the number of delay lines available for the image signal processor as well as computational limitations. Second, since it takes a few years to design, test, and produce an image signal processor, so the noise reduction algorithm is typically a few generations old. The camera pipeline introduces a number of artifacts such as false edges, sprinkles, and black/white pixel clumps that from a signal point-of-view are not noise but actually appear more like structure. These artifacts severely degrade image quality in bright light, especially in the sky regions (aka blue-sky noise), but they are especially severe in low-light. One way to mitigate noise as well as artifacts is to increase exposure time so that more photons can be accumulated in the sensor, but this introduces motion blur.

A sought after feature in digital cameras is image panorama. The camera takes multiple overlapping shots as the user pans the camera. These shots are stitched together. For consistency the stitching algorithm often times uses a weighted average of the overlapping pixels. This averaging alters the noise characteristics of the overlapped regions, giving the panorama a non-uniform look. A second issue with panorama is that to minimize motion blur, the exposure time is decreased. This mitigates motion blur, but results in severe noise in low-light, in both the luminance and chrominance channels.

Another feature in digital cameras is high dynamic range imaging. This typically combines multiple images of the same scene taken under different exposures combined with a dynamic tone map to bring out shadow detail. This operation is highly non-linear and content dependent, and therefore is not easily modeled in the frequency domain.

Owing to the complicated nature of image degradations in the processed domain, classical full-band, fixed threshold, schemes do not work very well, as described in U.S. Pat. No. 8,108,211. For example, since the noise is frequency dependent, if noise reduction algorithm parameters are chosen to remove noise of a certain frequency, for other frequencies the denoising will be either too much or too little, since the noise power varies with frequency. Transform domain methods such as wavelet denoising as described in J. Maarten et al, “Image de-noise by integer wavelet transforms and generalized cross validation”, pp. 622-630, Medical Physics, vol. 26 No. 4, Apr. 1, 1999, are relatively more complicated. Second, they split the frequency band in multiples of two, which may not be desirable or needed.

A band-split approach to image denoising has been described in U.S. Patent Application Publication Number 2008/0239094, which is hereby incorporated by reference. The idea is to accurately propagate noise amounts in each band from the sensor domain to the processed domain so that they can be used to set the noise reduction thresholds for each band. There are several problems with this approach.

This band-split method requires that every operation in the camera pipeline be modeled in the frequency domain so that band-wise noise variance (second order statistics) after each operation can be accurately predicted. Since pipeline artifacts share the same frequency band as structure, they cannot be modeled as noise and therefore cannot be mitigated without affecting the underlying image. The method is predicated on accurately modeling the frequency domain characteristics of spatial operations in the camera pipeline. It considers filtering, demosaicking, and sharpening. However, it does not address noise reduction, both spatial as well as temporal, which are also a part of any camera pipeline. Similarly, it is also silent on how to deal operations such as high-dynamic range enhancement where images taken at multiple exposures are combined using a local/global tone map to bring out shadow detail as well as what to do about stitching artifacts in image panorama. So at best the noise prediction is sub-optimal, hence, the noise reduction will not work as well as advertised. In a nutshell, this approach is built on the notion of propagating noise from the sensor, where it can be modeled, to any point in the imaging pipeline so that the threshold in the noise reduction algorithm can be accurately set for each band. However, as camera pipelines evolve and new features are added, the frequency domain characteristics of some highly non-linear operations, such as temporal and spatial noise reduction earlier in the pipeline, high dynamic range image formation, panorama stitching artifacts, more complex demosaicking algorithms, etc., and pipeline artifacts are hard to model.

### SUMMARY OF THE INVENTION

Embodiments according to the present invention provide image enhancement by separating the image signals, either Y or RGB, into a series of bands and performing noise reduction on bands below a given frequency but not on bands above that frequency. The bands are summed to develop the image enhanced signals. This results in improved sharpness and masking of image processing pipeline artifacts. Chroma signals are not separated into bands and noise reduction is applied. The higher frequency band is attenuated or amplified based on light level. The noise reduction has thresholds based on measured parameters, such as signal frequency, gain and light level, provided in a lookup table. The window size used for the noise reduction varies with the light level as well, smaller windows sizes being used in bright light and increasing window sizes as light levels decrease. Panoramic images are handled in a similar fashion.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a block diagram of a device according to the present invention.

FIG. 2 is an exemplary camera processing pipeline according to the present invention.

FIG. 3 is a block diagram of a low pass filter chain for band splitting according to the present invention.

FIG. 4 is a table of measured signal-to-noise levels for various light levels.

FIG. 5 is a block diagram of image enhancement according to the present invention.

FIG. 6 is a block diagram of image enhancement of a panoramic image according to the present invention.

### DETAILED DESCRIPTION OF THE PREFERRED EMBODIMENTS

FIG. 1 is a block diagram of an exemplary device 100, such as a camera or phone. An imager 102, as typical in such devices, is connected to an image processor 104. The image processor 104 is connected to storage 106 for both processing storage and longer term storage after completion of processing. The image processor 104 is also connected to a general processor 106 which performs more general duties. The general processor 108 is connected to a display no for providing a user the ability to view the current or previously stored images which the general processor 108 retrieves from storage 106. Storage 106 also stores the firmware and other software used by the image processor 104 and general processor 106 that perform the preferred embodiments. This is a very general overview and many variations can be developed, such as combining the image processor and general processor or forming the image processor using hardware, FPGAs, or programmed DSPs or some combination, as known to those skilled in the art.

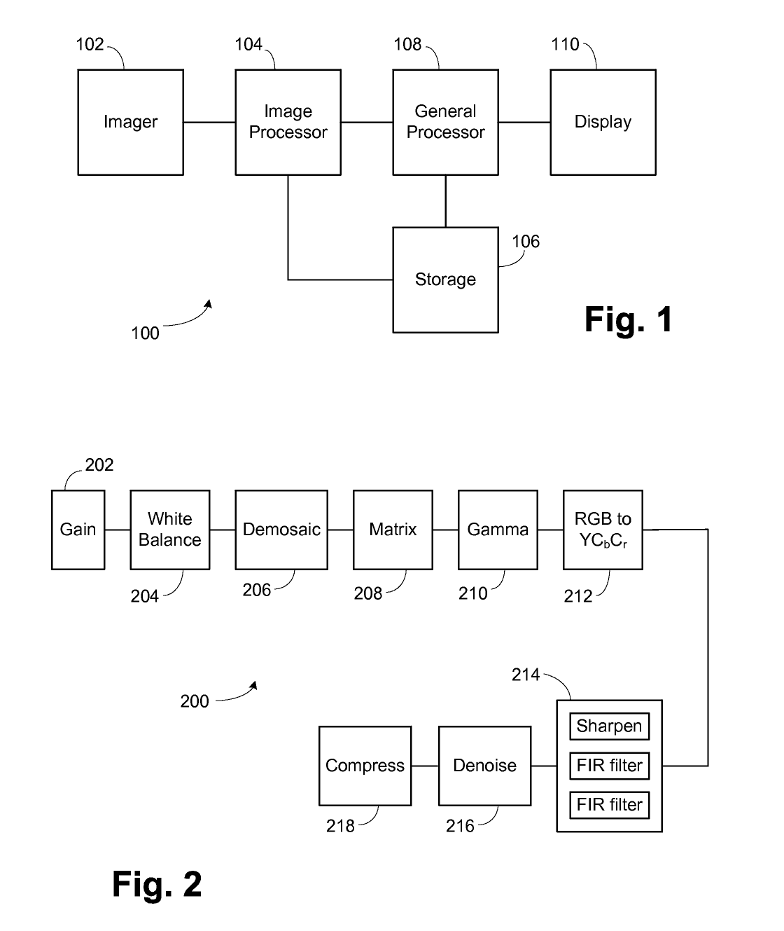

FIG. 2 shows a block diagram of an exemplary camera pipeline 200 that receives the output of the imager 102. The imager 102 sends a signal that has Gaussian, white and uncorrelated noise but has signal level dependence. The noise also has missing pixels (mosaicked). A gain component 202 produces high gain at low-light and low gain at high-light. Signal-noise behavior changes accordingly. A white balance component 204 changes gains for R, G and B depending on illumination. Furthermore, channel dependence exists after the white balance component 204. After using a demosaicking component 206 to demosaic complete RGB planes, there is frequency dependent inter-channel correlation. Specifically, G-channel high frequency noise is copied to the B and R channels, maintaining higher inter-channel correlation than at low frequency. After a matrix component 208 the inter-channel correlation is more complicated. After a gamma component 210, strong level dependence is added, and the noise is not Gaussian anymore. An RGB to YC_{b}Cᵣ matrix 212 may be used to convert to luma and chroma signals and adds additional inter-channel dependence. A sharpening/filtering component 214 boosts Y signal high frequency and bandlimits the C signals, causing additional frequency dependence. Denoising according to the present invention is applied in denoiser 216. Compression is done in the compress unit 218.

Rather than view this problem from the prism of image denoising, embodiments according to the present invention treat it from the perspective of image enhancement. The goal is to preserve a sharp impression, avoid a plasticky look, and remove objectionable low and mid frequency noise, as well as retain a certain amount of preference noise for masking pipeline artifacts. All these, in general, result in a more pleasing look.

Embodiments according to the present invention use an idea developed from blue-noise halftoning. The term “blue” refers to the high-frequency component, analogous to the high frequency blue component in the visible spectrum. Given the low-pass nature of the human visual system, retaining blue noise, or noise close to blue noise, has been found to be visually more appealing than retaining full-band noise since the spectra of blue noise is in the spectral region where the human eye is the least sensitive. This is achieved by splitting the image, signal as well as noise, into bands using a very simple low-pass or high-pass sequential filter bank as shown in FIG. 3.

The incoming luma data (or individual RG or B data) is provided to a first low pass filter 302. The incoming luma data has the output of the first low pass filter 302 subtracted by subtracting junction 304. The output of the subtracting junction 304, the full range luma data that has had the lowest frequency band removed, is provided to a second low pass filter 306 and a second subtracting junction 308. The second low pass filter 306 has a bandwidth similar to that of the first low pass filter 302 as preferably all of the bands are equal, though different size bands could be used if desired. The output of the second low pass filter 306 is provided to the subtraction input of the subtracting junction 308 so that the output of the subtracting junction is the luma data with the lowest two frequency bands removed. This chain continues until the final low pass filter 310 and the final subtracting junction 312. These both receive the luma data that has had all but the two highest frequency bands removed. The final low pass filter 310 removes the next to last band and provides its output to the subtraction input of the final subtracting junction 312. The output of the final subtracting junction 312 is the final, highest frequency band. In this manner the multiple bands are separated using the low pass filter bank. A high pass filter chain would be similar except that the output of the first filter would be the highest frequency band and the output of the final subtracting junction would be the lowest frequency band.

Noise reduction is performed on the low to mid frequency bands. The highest frequency band is added back to the denoised frequency bands to get the final result. In this manner, the objectionable low-to-mid frequency noise is removed while the high frequency noise, aka blue noise, is retained to convey a sharp impression as well as mask pipeline artifacts. This is illustrated in FIG. 5.

The luma data (or each of the RG and B channel data) is provided to a low pass filter bank 502, as shown in FIG. 3 and described above. The outputs of the low pass filter 502 except the highest frequency band are provided to noise reduction blocks 504, 506, whose preferred operation is described below. The highest frequency band is provided to an attenuation/amplification block 508. The degree of attenuation or amplification (k) for the highest frequency (blue noise) band is gain or light level adaptive. This is dependent on preference and sensor characteristics. Some prefer the image to be very sharp even at the cost of tolerating noise while others prefer a more balanced tradeoff. Certainly for bright scenes, there should be no attenuation, k=1. If more sharpness is desired k could be greater than 1. For low light levels where pipeline artifacts become more visible, k progressively becomes smaller (k<1). In the preferred embodiment for extremely low light levels k=0.5 is reasonable. The outputs of the noise reduction blocks 504, 506 and the attenuated or amplified highest frequency band are provided to a summing junction 510 to provide the enhanced luma signal (or respective RG or B signals). Because the human visual system is not very sensitive to high frequency variations in chroma and the chroma signals are generally also downsampled, for example 4:2:2, there is no need for a band-split approach to the chroma signals and noise reduction 512 is directly applied to chroma channels, with the luma channel used in the noise reduction to avoid blurring colors in low light situations.

While a variable number of bands is illustrated, in most cases either two or three bands is sufficient. The bands do not have to be of equal size, and preferably are not. In the two band case, the filter frequency is set to select the low to mid frequency signals for noise reduction, while the high frequency is not noise reduced as discussed above. This provides the desired image enhancement while minimizing required computations. If three bands are used, low, mid and high, different noise reduction parameters can be used on the low and mid bands.

The noise reduction is preferably adaptive. As the ambient light level decreases, the camera pipeline progressively applies a bigger gain to get an acceptable image. The higher gain not only increases the signal, it also amplifies the noise. The preferred embodiments make the noise reduction algorithm parameters, window sizes; thresholds; and the attenuation factor for feeding back the highest frequency band, dependent on camera gain. For instance a smaller window (9×9) is used for bright light where low-frequency noise is not very noticeable but a progressively bigger kernel (11×11, 13×13, . . . ) is used for lower light. Similarly, for bright light scenes the cutoff frequency for the highest frequency band is higher than the cutoff frequency for low-light scenes. The reason is that pipeline artifacts in bright light are not as dominant as they are in low light. Hence to mask artifacts in low light, more noise needs to be retained, therefore the lower cutoff. This allows a consistent image quality to be maintained over a wide range of light levels.

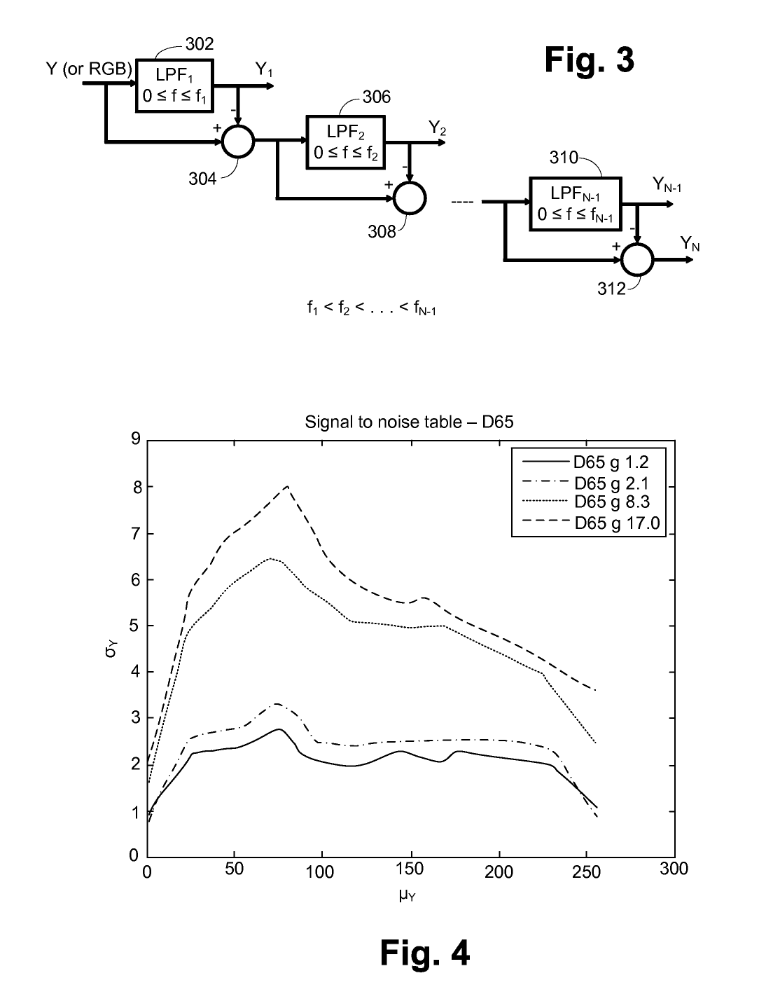

As earlier pointed out, predicting noise by propagating noise from raw to processed domain is quite difficult for modern camera pipelines. The preferred embodiments take a measurement approach. Noise levels in the 17 grayscale patches in the X-Rite ColorChecker Digital SG from X-Rite, Inc. are measured in a light booth for various illuminants and varying light levels such that the full gain range (min gain to max gain) is spanned. The 17 measurements are interpolated over a full 8-bit processed signal range to obtain a measured signal-to-noise table that depends on signal, gain, and illuminant. An example 3D lookup table (LUT) is shown in FIG. 4. In the table each line is a different camera gain value (g). The axes are μ and σ, where μ is the mean value and σ is the standard deviation. Because there is noise, the pixel values within each grayscale patch will have some variation. If the number of pixels in each grayscale patch is large enough, the mean of the pixels corresponds to the signal and the standard deviation gives an estimate of the noise. The intermediate values are interpolated from nearest entries in the 3D LUT. For given image conditions, illuminant and camera gain, thresholds can be accurately selected for each pixel from the 3D LUT. If memory is an issue, a simple model is used, such as threshold=min(slope*Y, max-threshold), where slope and max-threshold are chosen so that the resulting threshold fits a measured signal-to-noise table. These thresholds are then used in the preferred noise reduction algorithm.

In the pipeline, such as of FIG. 2, this preferred method is applied to the luma channel (Y) before compression, which occurs after the sharpening/filtering component 214. The chroma channels do not need a band-split approach, any simple denoising method, including those of the prior art, can be used for them. Luma and chroma examples are used as processing in the luma/chroma space is preferred as the brightness information to which the human visual system is most sensitive is limited to the luma channel, reducing processing requirements. If operation in the RGB space is desired, then the band pass filtering and lower band noise reduction operations are performed on each color.

Offline processing can also be done so that the denoising operation of block 216 is not done before the image is stored after the pipeline processing is completed. If the image is in RGB format, the RGB data is converted to YC_{b}Cᵣ format. The preferred method of applying the image enhancement scheme to the Y channel and any simple noise reduction for the chroma channels is then performed. Finally the denoised YC_{b}Cᵣ data is converted back to RGB data if desired. This can be done automatically on the device, in the background, while the user is free to do other tasks or the user can initiate the enhancement as a one-touch process. Similarly, this offline processing method can be a part of a desktop image processing software such as Aperture from Apple Inc.

For high dynamic range imaging, the above image enhancement can occur for each of the multiple images prior to combination or can be done on the combined image. The various parameters will differ between the two methods, individually and combined.

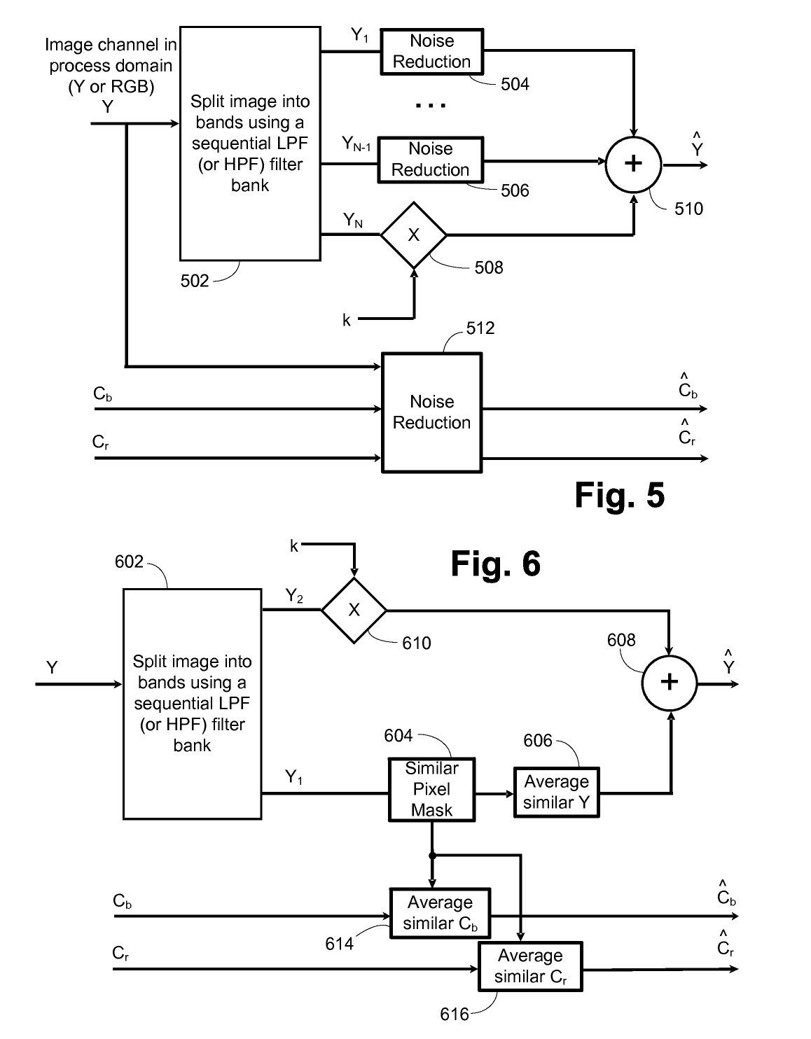

As discussed above, to avoid motion blur, panorama mode has much lower exposure times, which drastically increases noise in low light, in both the luma and chroma channels. A slightly different method is used in the panorama instances, as shown in FIG. 6. In operation 602 the luma channel is processed as above using the sequential filter bank. Then for the lower frequency bands, in operation 604 the images are processed to develop a similar pixel mask. Based on the similar pixel mask, operation 606 averages the similar luma locations to provide the noise reduced luma signals. The upper frequency band is attenuated or amplified as described above in operation 608, with no need for a pixel mask or averaging as no noise reduction is being done. Operation 610 sums the upper frequency band and the averaged lower frequency bands to develop the final luma data. Because of the correlations of noise in the luma and chroma channels, the luma similar pixel mask developed in operation 604 is used to manage the averaging done on the chroma channels in operations 614 and 616 to provide the noise reduced chroma signals.

In an alternate embodiment, instead of using the similar pixel mask from the luma channel, similar pixel locations can be determined from all three channels, i.e. if the absolute luma difference is below a signal dependent luma threshold, and the absolute difference of the first chroma channel is less than another threshold, and the absolute difference of the second chroma channel is less than a third threshold, then the pixel is considered similar. The results then form an alternate embodiment of the similar pixel mask of operation 604.

In another embodiment and similar to FIG. 5, the luma channel can be used in the noise reduction process to avoid blurring colors in low light situations.

The steps involved in constructing a panorama are taking several shots while panning, registration, and blending. Noise reduction can be done at the end of the full panorama or on each individual shot before registration. The advantage of doing noise reduction on the full panorama is that it is more efficient that doing noise reduction on each individual shot since there is considerable overlap between consecutive shots. However, if noise reduction is done on individual shots, registration and blending works better. The described scheme can work in either situation.

By splitting the luma or RGB signals into bands and applying noise reduction to all the bands below a given frequency and applying adaptive attenuation or amplification based on light levels to the bands above the given frequency, and then summing the bands to provide the full bandwidth signals, image enhancement is done. The band approach does not need to be used on chroma signals. Noise reduction is done based on thresholds developed by measurements taken for three different parameters, frequency, light level and gain, and by varying window sizes according to light level, with smaller window sizes for brighter light levels.

It should be emphasized that the previously described embodiments of the present invention, particularly any preferred embodiments, are merely possible examples of implementations, set forth for a clear understanding of the principles of the invention. Many variations and modifications may be made to the previously described embodiments of the invention without departing substantially from the spirit and principles of the invention. All such modifications and variations are intended to be included herein within the scope of this disclosure and the present invention and protected by the following claims.

We claim:

1. A method for image enhancement comprising:
receiving signals from an imager;
processing the signals received from the imager;
separating at least one of the processed signals into a plurality of bands;
applying noise reduction to all bands below a first frequency;
not applying noise reduction to all bands above the first frequency;
applying adaptive gain to all bands above the first frequency; and
summing all of the bands after either noise reduction or gain to produce an image enhanced signal.

2. The method of claim 1, wherein the processed signals are luma and chroma signals, and wherein only the luma signal is separated into a plurality of bands, the method further comprising:
applying noise reduction to the chroma signals.

3. The method of claim 1, wherein the processed signals are R, G and B signals and all three signals are separated into a plurality of bands.

4. The method of claim 1, wherein the step of separating into a plurality of bands is done using a low pass filter bank.

5. The method of claim 1, wherein the step of separating into a plurality of bands is done using a high pass filter bank.

6. The method of claim 1, wherein the step of applying adaptive gain applies gain based on the light level.

7. The method of claim 6, wherein the gain is unity for light levels above a first level and decreases proportionally to the light level for light levels below the first level.

8. The method of claim 1, wherein the noise reduction is performed for data above a given threshold, the threshold developed based on measured values of light level, frequency and gain.

9. The method of claim 1, wherein the noise reduction is performed using windows sizes that increase as the light level decreases.

10. A method for image enhancement of adjacent panoramic images comprising:
receiving signals of adjacent panoramic images from an imager;
processing the signals received from the imager;
separating at least one of the processed signals into a plurality of bands;
developing a similar pixel mask for all bands of the separated signals below a first frequency;
averaging the signals for all bands of the separated signals below the first frequency based on the similar pixel mask;
not averaging all bands of the separated signals above the first frequency;
applying adaptive gain to all bands of the separated signals above the first frequency; and
summing all of the bands of the separated signals after either averaging or gain to produce image enhanced signals.

11. The method of claim 10, wherein the processed signals are luma and chroma signals, and wherein only the luma signal is separated into a plurality of bands, the method further comprising:
averaging the chroma signals based on the similar pixel mask developed for the luma signal.

12. The method of claim 10, wherein the processed signals are R, G and B signals and all three signals are separated into a plurality of bands.

13. A program storage device, readable by at least one processor and comprising instructions stored thereon to cause the at least one processor to perform a method for image enhancement comprising the steps of:
receiving signals from an imager;
processing the signals received from the imager;
separating at least one of the processed signals into a plurality of bands;
applying noise reduction to all bands below a first frequency;
not applying noise reduction to all bands above the first frequency;
applying adaptive gain to all bands above the first frequency; and
summing all of the bands after either noise reduction or gain to produce an image enhanced signal.

14. The program storage device of claim 13, wherein the processed signals are luma and chroma signals, and wherein only the luma signal is separated into a plurality of bands, the method further comprising the steps of:
applying noise reduction to the chroma signals.

15. The program storage device of claim 13, wherein the processed signals are R, G and B signals and all three signals are separated into a plurality of bands.

16. The program storage device of claim 13, wherein the step of separating into a plurality of bands is done using a low pass filter bank.

17. The program storage device of claim 13, wherein the step of separating into a plurality of bands is done using a high pass filter bank.

18. The program storage device of claim 13, wherein the step of applying adaptive gain applies gain based on the light level.

19. The program storage device of claim 18, wherein the gain is unity for light levels above a first level and decreases proportionally to the light level for light levels below the first level.

20. The program storage device of claim 13, wherein the noise reduction is performed for data above a given threshold, the threshold developed based on measured values of light level, frequency and gain.

21. The program storage device of claim 13, wherein the noise reduction is performed using windows sizes that increase as the light level decreases.

22. A program storage device, readable by at least one processor and comprising instructions stored thereon to cause the at least one processor to perform a method for image enhancement of adjacent panoramic images comprising the steps of:
receiving signals of adjacent panoramic images from an imager;
processing the signals received from the imager;
separating at least one of the processed signals into a plurality of bands;
developing a similar pixel mask for all bands of the separated signals below a first frequency;
averaging the signals for all bands of the separated signals below the first frequency based on the similar pixel mask;
not averaging all bands of the separated signals above the first frequency;
applying adaptive gain to all bands of the separated signals above the first frequency; and
summing all of the bands of the separated signals after either averaging or gain to produce image enhanced signals.

23. The program storage device of claim 22, wherein the processed signals are luma and chroma signals, and wherein only the luma signal is separated into a plurality of bands, the method further comprising the steps of:
averaging the chroma signals based on the similar pixel mask developed for the luma signal; and
applying noise reduction to the chroma signals.

24. The program storage device of claim 22, wherein the processed signals are R, G and B signals and all three signals are separated into a plurality of bands.

25. An image capturing device comprising:
an imager; and
a processing system coupled to said imager and configured to perform a method of image enhancement including the steps of
receiving signals from said imager;
processing the signals received from said imager;
separating at least one of the processed signals into a plurality of bands;
applying noise reduction to all bands below a first frequency;
not applying noise reduction to all bands above the first frequency;
applying adaptive gain to all bands above the first frequency; and
summing all of the bands after either noise reduction or gain to produce an image enhanced signal.

26. The image capturing device of claim 25, wherein the processed signals are luma and chroma signals, and wherein only the luma signal is separated into a plurality of bands, the method further comprising the steps of:
applying noise reduction to the chroma signals.

27. The image capturing device of claim 25, wherein the processed signals are R, G and B signals and all three signals are separated into a plurality of bands.

28. The image capturing device of claim 25, wherein the step of separating into a plurality of bands is done using a low pass filter bank.

29. The image capturing device of claim 25, wherein the step of separating into a plurality of bands is done using a high pass filter bank.

30. The image capturing device of claim 25, wherein the step of applying adaptive gain applies gain based on the light level.

31. The image capturing device of claim 30, wherein the gain is unity for light levels above a first level and decreases proportionally to the light level for light levels below the first level.

32. The image capturing device of claim 25, wherein the noise reduction is performed for data above a given threshold, the threshold developed based on measured values of light level, frequency and gain.

33. The image capturing device claim 25, wherein the noise reduction is performed using windows sizes that increase as the light level decreases.

34. An image capturing device comprising:
an imager; and
a processing system coupled to said imager and configured to perform a method of image enhancement of adjacent panoramic images including the steps of:
receiving signals of adjacent panoramic images from said imager;
processing the signals received from said imager;
separating at least one of the processed signals into a plurality of bands;
developing a similar pixel mask for all bands of the separated signals below a first frequency;
averaging the signals for all bands of the separated signals below the first frequency based on the similar pixel mask;
not averaging all bands of the separated signals above the first frequency;
applying adaptive gain to all bands of the separated signals above the first frequency; and
summing all of the bands of the separated signals after either averaging or gain to produce image enhanced signals.

35. The image capturing device of claim 34, wherein the processed signals are luma and chroma signals, and wherein only the luma signal is separated into a plurality of bands, the method further comprising the steps of:
averaging the chroma signals based on the similar pixel mask developed for the luma signal; and
applying noise reduction to the chroma signals.

36. The image capturing device of claim 34, wherein the processed signals are R, G and B signals and all three signals are separated into a plurality of bands.
